(19) United States
(12) Patent Application Publication
(10) Pub. No.: US 2015/0230431 A1
(43) Pub. Date: Aug. 20, 2015

(54) CLEAN LEASH DEVICE FOR PET WASTE CONTAINMENT AND DISPOSAL

(71) Applicant: Dexter Earl Patterson, JR., Riverside, RI (US)

(72) Inventor: Dexter Earl Patterson, JR., Riverside, RI (US)

(21) Appl. No.: 14/185,069

(22) Filed: Feb. 20, 2014

(51) Int. Cl. A01K 27/00; B65D 33/00; B65D 30/08; E01H 1/12; B65D 25/22

(52) U.S. Cl. CPC A01K 27/008; E01H 1/1206; B65D 25/22; B65D 29/02; B65D 33/002; E01H 2001/126; E01H 2001/128; E01H 2001/1286

(57) ABSTRACT

A pet leash accessory and storage bag which attaches to various leases on the market. The bag includes a front upper pocket for storing hand sanitizer. The bag provides a front lower storage pocket with an opening at the top of the pocket for placement and storage of a roll of disposable unused pet waste bags and a vertical opening in the center of the front lower pocket for dispensing the perforated unused pet waste bags individually. Additionally, this leash bag contains a hollow interior housing which stores a nylon waste containment pouch. The nylon waste bag can be extracted from the housing for temporary storage of the used pet waste bags. The nylon waste containment pouch is attached by its upper corner to the main housing to provide hands-free containment of pet waste.

### BACKGROUND INFORMATION

1. Field

This invention is related to the field of pet leash accessories and pet care. More specifically, the present invention relates to the field of pet waste collection and disposal by providing a soft durable and easily cleanable leash attachment which incorporates separate compartments for pet waste bag containment and dispensing, storage of pet waste, and storage of personal-sized bottle of hand sanitizer.

2. Background

Leash laws and pet waste laws have presented pet owners with problems and inconveniences in walking and enjoying their pets outdoors. Specifically, pet owners are increasingly required to secure pets to leashes while interacting with their pets outdoors. Furthermore, pet owners face the additional problem of collecting and disposing of pet waste while outdoors.

Therefore, it is desirable to provide a convenient, lightweight, and sanitary device which stores and dispenses disposable pet waste bags. It is equally desirable that the device contain a separate housing for temporary storage of the used waste bags and an additional housing providing for storage of personal sized sanitation lotion. This convenient accessories can attach securely to any leash, which precludes pet owners from having to carry additional items while walking their pets.

### SUMMARY OF INVENTION

This invention is a convenient, lightweight and inexpensive leash accessory designed for use by pet owners while engaging with their pets outdoors. The primary use of this invention is to provide pet owners with a safe, convenient and sanitary method to collect and store pet waste until the pet owner can find a suitable waste receptacle.

The preferred embodiment provides a canvas strap connected at the top of the invention for placement of a fastener clip for attachment to a plurality of leashes on the market. An elongated fabric main body is folded in equal halves and sewn together at the top and bottom portions to form a hollow interior housing for storage of the nylon pet waste containment bag. The nylon pet waste bag has a fixation point which attaches it in the hollow interior housing of the main body. When not in use, the nylon containment bag may be folded and stored within the housing, which is secured by a hook and loop closure.

Additionally, a top fabric portion is incorporated onto the upper front of the main body. The fabric portion is sewn onto the main body on both sides and the bottom defining an inner cavity for storage. This top fabric cavity, or pocket, is made of the same fabric as the main body and provides the housing for a bottle of personal hand sanitizer to be used after the collection and storage of pet waste. An elastic holder is secured inside this top pocket for insertion and securing of the hand sanitizer.

Two equal sized bottom fabric portions are incorporated onto the lower portion of the front of the main body. These bottom fabric portions are sewn onto the main body on both sides and the bottom defining an inner bottom pocket. The bottom pocket houses a roll of disposal pet waste containment bags and a vertical foramen provides for the convenient dispensing of individual pet waste bags as needed.

The advantages afforded by these features allow pet owners to safety collect their pet's waste in the disposal bags and securely store these filled waste bags in the nylon containment bag until permanent disposal. An additional advantage is shown in the storage pocket for the hand sanitizer, which the pet owner uses after collection of the pet waste.

### BRIEF DESCRIPTION OF THE DRAWINGS

FIG. 1 is a view of the preferred embodiment.

FIG. 2 is a view of the front of the main body of FIG. 1.

FIG. 3 is an isometric view of the main body of FIG. 2, prior to the main body being folded onto itself.

FIG. 4 is a view of FIG. 1 showing the nylon waste containment pouch when extracted from the inner cavity of the main body.

FIG. 5 is a view of FIG. 1 showing a roll of disposable pet waste containment bags 10 and the opening of the lower front roll pocket for placement of the roll of pet waste containment bags 11.

FIG. 6 is a view of the left and right portions of the roll pocket attached to the lower half of the main body shown in FIG. 4.

FIG. 7 is a view of the Sanitizer pocket attached to the upper half of the main body.

FIG. 8 is a view of the elastic holder in the Sanitizer Pocket.

FIG. 9 is a view of the Canvas Strap attached to the top of the main body.

FIG. 10 is a view of the Waste Pouch.

### DETAILED DESCRIPTION

The embodiments described herein disclose a durable and easily cleanable soft canvass leash attachment with a plurality of containment pockets for storage of personal-sized hand sanitizer, storage of a roll of pet waste containment bags and the collection and temporary storage of pet waste while outdoors with pets.

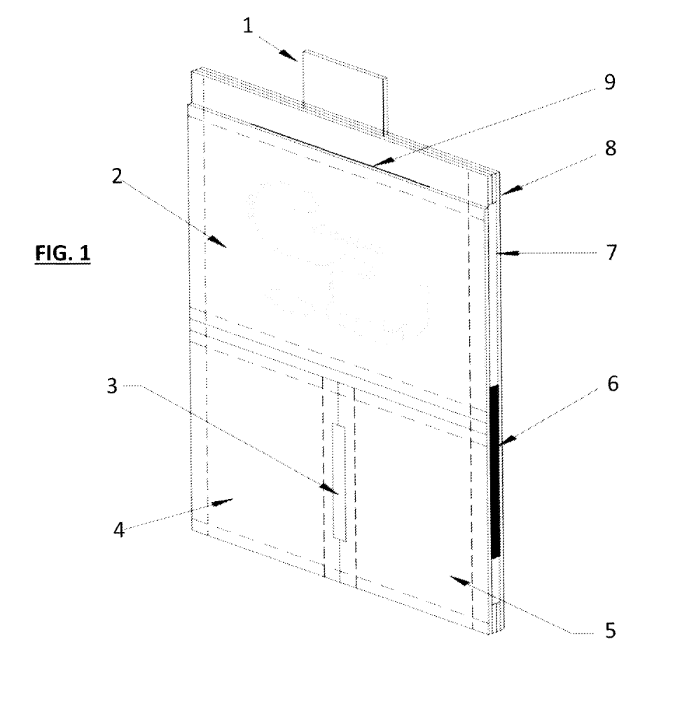

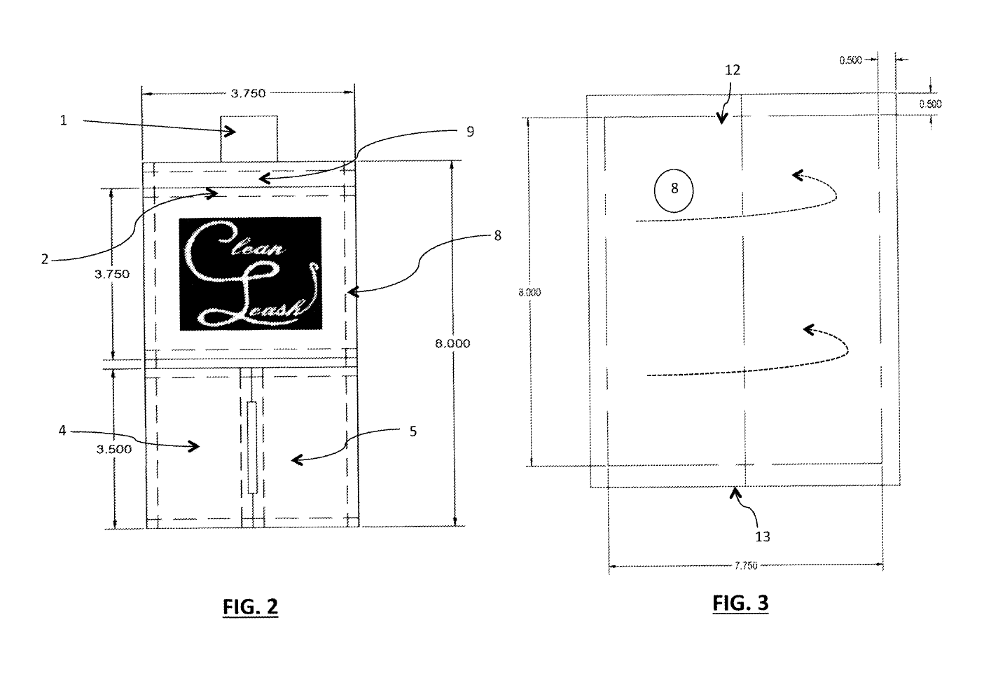

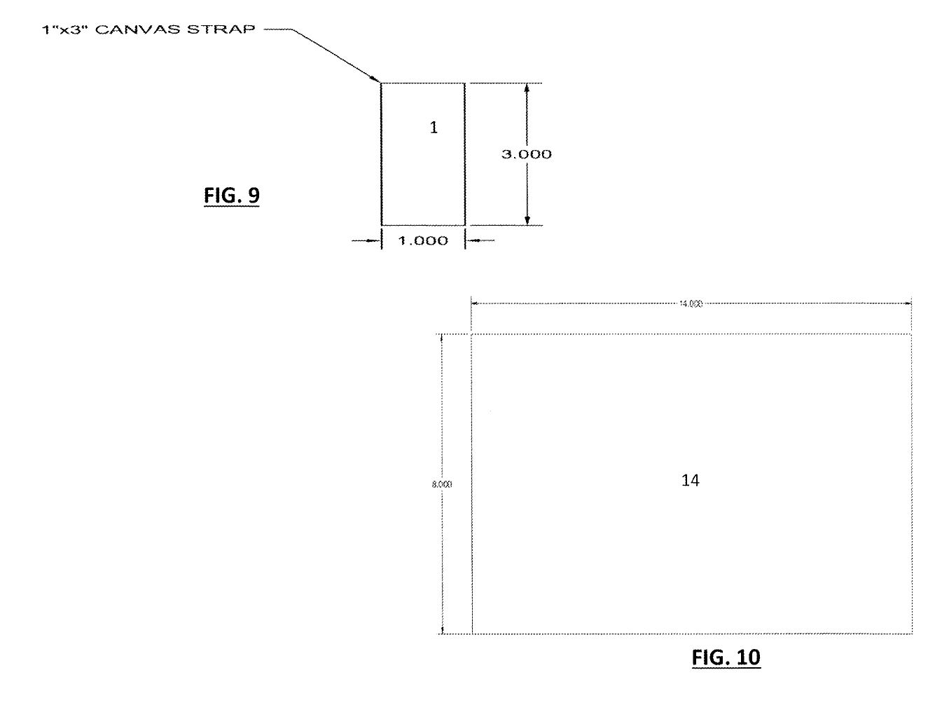

Referring to the drawings, FIGS. 1-3 provide various views of the main body 8 with a canvas strap 1 secured at the top center of the main body 8, for attaching to a fastener clip (not shown). FIG. 9 provides a view of the canvas strap 1.

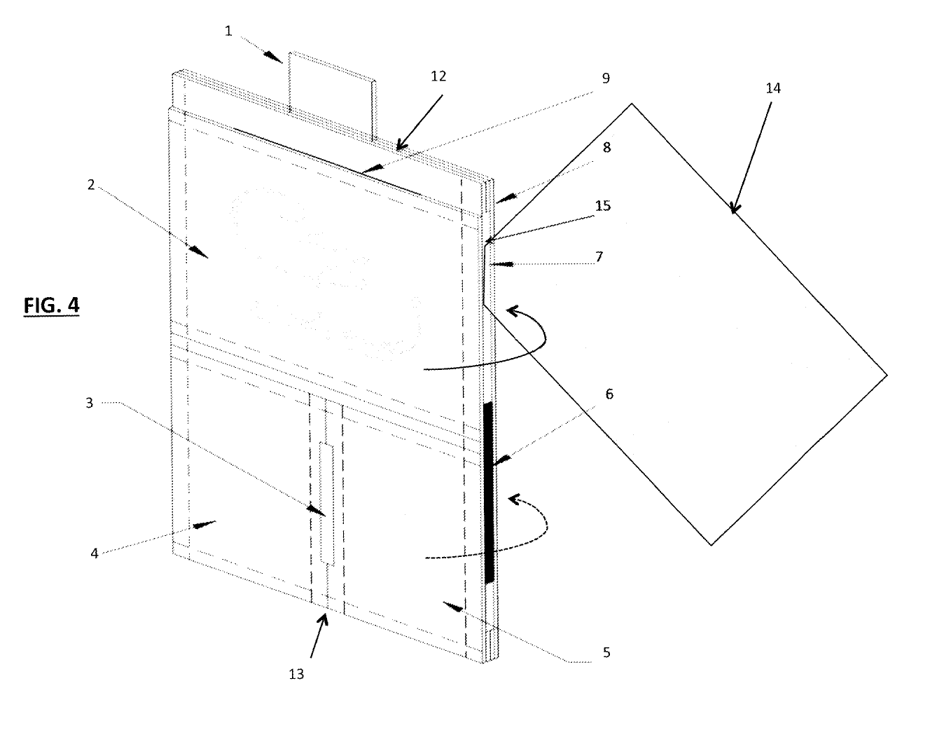

As shown in FIGS. 3 and 4, the elongated main body 8 is folded onto itself and sewn together at the top 12 and bottom 13 portions to form a hollow interior housing 7 for storage of the nylon pet waste containment bag 14 when not in use.

The nylon pet waste bag 14 shown in FIG. 4 and detailed in FIG. 10 has a fixation point 15 which attaches it in the hollow interior housing 7. When not in use, the nylon containment bag 14 may be folded and stored within the housing 7, which is secured by a hook and loop closure 6.

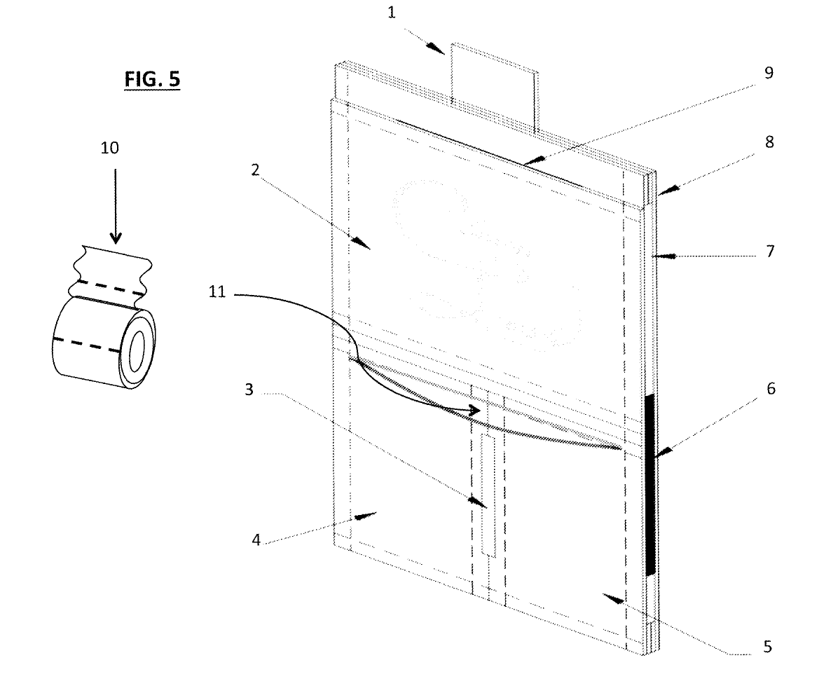

FIG. 5 provides a view of the main body 8 with the various compartments within. Incorporated into the upper front of the main body 8 is a front pocket 2, further illustrated in FIG. 7. The front pocket 2 is sewn into the front main body 8 and defines an inner cavity for storage of a bottle of personal-sized hand sanitizer (not shown). Said bottle of personal-sized hand sanitizer is secured by an elastic holder 9. FIG. 8 details the elastic holder 9, which is sewn on each end to the upper inner portion of the front pocket 2.

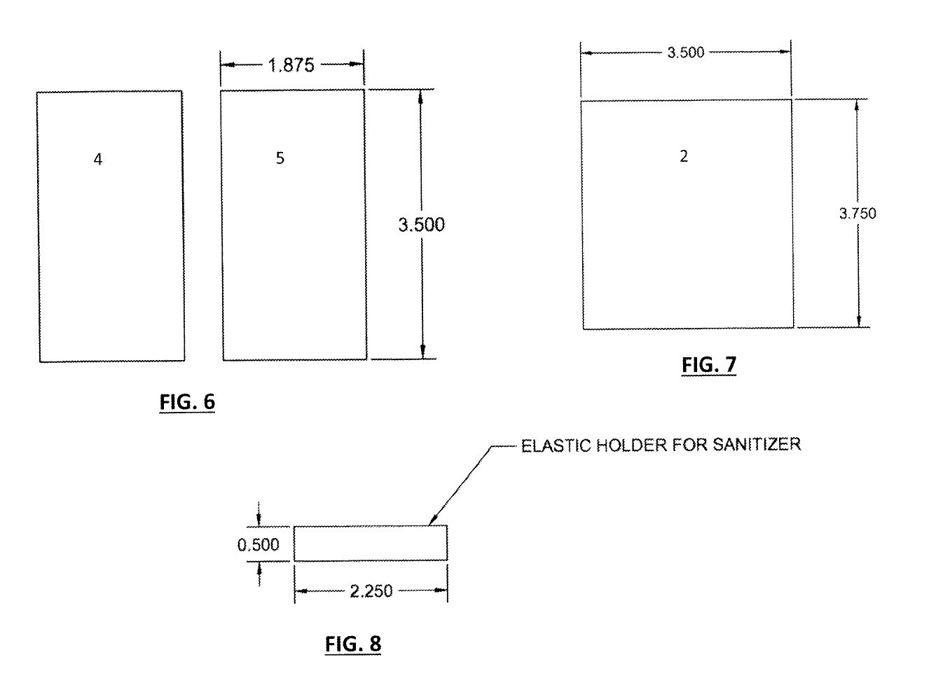

Additionally, FIG. 5 provides a view of the lower left roll pocket 4 and the lower right roll pocket 5 as each are sewn into the lower portion of the main body 8 to define an inner cavity 11 holding therein a roll of a plurality of biodegradable pet waste storage bags 10. FIG.6 details the lower left roll pocket 4 and the lower right roll pocket 5 prior to attachment to the main body 8.

The biodegradable pet waste storage bags 10, as shown in FIG. 5 are connected end to end and are perforated for easy separation of a single bag from the roll 10. The inner cavity 11 allows for storage of the biodegradable pet waste storage bags 10, which are inserted into the inner cavity through the top open end of the defined inner cavity 11. A slotted aperture 3 is defined at the midpoint of the lower left roll pocket 4 and the lower right roll pocket 5. This slotted aperture 3 allows for extraction of a single biodegradable pet waste storage bag 10, without removing the roll of biodegradable pet waste storage bags from the inner cavity 11. This allows the pet owner to extract single biodegradable pet waste storage bags 10 as needed for pet waste containment without the need to use both hands, thus preventing the pet owner from having to release the hand securing the leash.

What is claimed is:

1. A pet waste storage device attachable to a pet leash comprising:
a durable, washable material folded and dividing the width of said material into equal front and back sides forming a main housing;
a waste containment bag attached at its upper edge to the inner pocket of the main housing compartment wherein the waste containment bag is retractable from the inner compartment to open and hold the used disposable pet waste bags and further adapted to collapse and store in the inner compartment when empty;
a top fabric body attached to the front upper exterior of the main housing having a top opening for storage and an inner elastic strap for securing items within;
a moiety of fabric bodies attached to the front lower exterior of the main housing bag defining a lower pocket within;
said fabric bodies forming a vertical center aperture for dispensing pet waste containment bags and having a top opening for receiving pet waste bags;
a plurality of pet waste bags maintainable within the lower pocket defined by the moiety of fabric bodies, said bags being removable through the aperture of the bottom pouch; and
a strap attached at the top of the main housing for attachment to a variety of leashes.

2. The pet waste storage device of claim 1, wherein the main housing compartment opening is secured by hook and loop fastening strap.

3. The pet waste storage device of claim 1, wherein the inner portion of the aperture defined in the lower fabric body is lined with a stiffening laminate to aid in the dispensing of the disposable pet waste containment bags.
